(19) United States
(12) Patent Application Publication
(10) Pub. No.: US 2010/0085297 A1
(43) Pub. Date: Apr. 8, 2010

(54) DISPLAY SYSTEM AND METHOD OF CONTROLLING A DISPLAY SYSTEM

(75) Inventor: Petrus M. De Greef, Waalre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/597,461

(22) PCT Filed: Apr. 24, 2008
(86) PCT No.: PCT/IB08/51579

§ 371 Date: Oct. 23, 2009

(30) Foreign Application Priority Data
May 2, 2007 (EP) 07107313.4

(51) Int. Cl. G09G 3/36

(52) U.S. Cl. 345/102

(57) ABSTRACT

The present invention relates to a display system which comprises an LCD display panel (DP) for displaying video signals from a video source (VS), and a backlighting unit (BL) for backlighting the display panel (DP). Furthermore, a luminance analyzing unit (LA) is provided for analyzing the luminance of at least parts of the video signals from the video source (VS). A backlighting control unit (BC) is provided for controlling the operation of the backlighting unit (BL) based on at least a first or second color temperature of a white-point setting according to the analyzing results of the luminance analyzing unit (LA).

### FIELD OF THE INVENTION

The present invention relates to a display system and method of controlling a display system.

### BACKGROUND OF THE INVENTION

Solid-state lighting systems, for example as part of an LCD-TV system with an LCD display module, have a white-point with a correlated colour temperature, wherein the colour temperature of a light source corresponds to the Kelvin temperature of a theoretical heated black-body radiator which has a hue which matches the hue of the light source. The colour temperature of the white-point of the solid-state lighting system may for example correspond to 9300 K. The video input data of the LCD-TV system, e.g. in a sRGB input format, may has a standardized white-point with a correlated colour temperature of 6500 K. Therefore, the colour temperature of the white-point of the solid state lighting system must be set to 6500 K if a realistic colour reproduction of the standard video sources based on a sRGB format is desired.

On the other hand, LCD-TV system with a solid-state lighting system may have a high colour temperature (9300 K) as the backlighting may have a higher luminance efficiency or as the display of bright scenes appear to be perceptionally brighter.

Due to the mismatch in the colour temperature of the white-point in the display system and the white-point of the sRGB video input format, the images which are reproduced on the LCD-TV system with a solid state lighting systems may be displayed with wrong colours. An exception may be present for colours which are very saturated. On the other hand, pastel colours like skin tones can be detected and modified to preserve a healthy looking colour, e.g. of a face of a person. To avoid the reproduction of images with wrong colours, all colours should be reproduced with a white-point setting which corresponds to the white-point setting of the input video data format, e.g. sRGB format=6500 K. It should be noted that when unsaturated bright colours are reproduced with a white-point setting of 9300 K as in LCD-TV backlight systems, the human perception sees a brighter image as with a corresponding white-point setting of 6500 K, hence has a preference.

EP 0915363A2 discloses a method for adjusting the colour temperature of a LCD with backlighting. The backlighting comprises lamps with different colour temperatures, wherein lamps with the same colour temperature are switched on together.

### SUMMARY OF THE INVENTION

It is therefore an object of the invention to provide a solid state lighting system which is able to adapt to the white point setting of an input video format.

This object is solved by a solid state lighting system according to claim 1 and a method according to claim 6.

Therefore, a display system is provided which comprises an LCD display panel for displaying video signals from a video source, and a backlighting unit for backlighting the display panel. Furthermore, a luminance analyzing unit is provided for analyzing the luminance of at least parts of the video signals from the video source. A backlighting control unit is provided for controlling the operation of the backlighting unit based on at least a first or second color temperature of a white-point setting according to the analyzing results of the luminance analyzing unit.

The invention also relates to a method for controlling a display system. Video signals from a video source are displayed on display panel. The display panel is backlight by a backlighting unit. The luminance of at least parts of the video signals from the video source is analyzed by a luminance analyzing unit. The operation of the backlighting unit is controlled by a backlighting control unit based on at least a first or second colour temperature of a white-point setting according to the analyzing results of the luminance analyzing unit.

According to an aspect of the present invention the backlighting control unit is adapted to control the operation of the backlighting unit by changing the colour temperature of the white-point setting to the first colour temperature for those parts of the video signal which are unsaturated and bright, wherein the first colour temperature corresponds the 9300K.

According to an aspect of the present invention the backlighting control unit is adapted to control the operation of the backlighting unit by changing the colour temperature of the white-point setting to the second colour temperature for those parts of the video signal which are darker, wherein the second colour temperature corresponds the 6500K.

According to a further aspect of the present invention the backlighting control unit is adapted to control the operation of the backlighting unit by changing the colour temperature of the white-point setting to an intermediate value between the first and second colour temperature.

According to still a further aspect of the present invention the backlighting control unit is adapted to control the operation of the backlighting unit by changing the colour temperature of the white-point setting per segment between the first and second colour temperature wherein the number of segments corresponds to the total number of individual controllable light sources of the display system.

The present invention relates to the idea to provide a display system e.g. with an LCD-panel as display. The LCD-TV may comprise a driving unit for driving the LCD-TV backlight based on two different white-point settings, namely e.g. 6500 K for realistic colours and e.g. 9300 K for bright white colours. The video data of the image is analyzed to determine unsaturated bright parts of an image. (If a dimming backlight is used in the solid state lighting system, this analysis has to be performed anyway). A colour control is implemented locally towards segments of a (dimmable) RGB LED backlight, wherein the colour is controlled according to the luminescence of the input images or parts thereof. Hence, the colour temperature of darker areas in the input image is changed towards e.g. 6500 K while the colour temperature of other brighter areas in the input image is changed towards e.g. 9300 K.

### BRIEF DESCRIPTION OF THE DRAWINGS

The advantages and embodiments of the present application will now be described in more detail with reference to the FIGURE.

FIG. 1 shows a basic illustration of a display system according to the present invention.

### DETAILED DESCRIPTION OF EMBODIMENTS

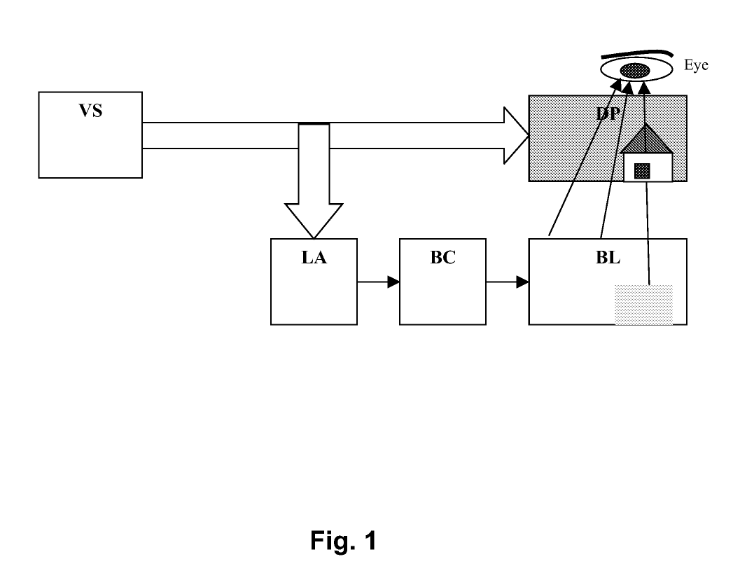

FIG. 1 shows a basic representation of a display system according to the first embodiment. An (external) video source VS is coupled to a LCD display panel DP where the video signal from the video source VS is displayed. A backlight BL is associated to the display panel DP for backlighting the display panel DP. The video or image data from the video source VS is also forwarded to luminescence analyzer LA (preferably a 2D-luminescence analyzer) which serves to analyze the luminescence of the video or image data from the video source VS. Furthermore, a backlight control unit BC is provided which controls the operation of the backlight BL according to the results of the luminescence analyzer LA. Preferably, the backlight control BC is implemented as a 2D-backlight control.

The backlight control BC is adapted to drive the backlight of the SSL system according to the analyzed luminescence of the input video signal from the video source VS. If the luminescence analyzer LA detects that parts of the input video image have darker areas, then the colour temperature of the backlight for those darker areas is changed towards 6500 K. However, if the luminescence analyzer LA detects that brighter areas are present in the input video image, the colour temperature of the backlight for those areas is changed towards 9300 K. The video-content in the video signal however is not processed, the smooth luminance profiles of the backlight segments prevent color artifacts at the boundary of the bright objects.

Accordingly, an analysis of the input video signal by the luminance analyzer LA is required to determine unsaturated bright parts of the image. If the backlight BL is implemented as a dimmable backlight for the purpose dynamic contrast and power savings, such a luminescence analysis is already required.

If parts of the image are unsaturated and bright while other parts of the image are dark, each of those parts need to be reproduced with an optimal white-point setting corresponding to the optimal setting of the respective part. The backlight control unit BC will control the operation of the backlighting accordingly. If a decision between the two settings of the white-point is not clear, the colour point can be driven with an intermediate value between 6500 K and 9300 K. Pixels at the border of the areas will have a white-point setting with a colour temperature in between those values as the light from those two light sources mixes before they pass through the LCD display panel.

The backlighting control unit BC can control the operation of the backlighting unit BL by changing the colour temperature of the white-point setting per segment between the first and second colour temperature. The number of segments may corresponds to the total number of individual controllable light sources of the display system, ranging from 1 (0D) to many (2D).

Although in the above, the first embodiment has been described with respect to a 2D-RGB controllable backlight, the present invention may also be implemented with a 0D, 1D, 2D and 2D-colour RGB controllable backlight.

The present invention can be implemented in a LCD-TV or other personal/automotive multimedia displays. The LCD-TV can be driven by a RGB dimmable backlight to implement a 2D dimmable backlight. Alternatively 2 types of (White) LEDs can be used to generate these two white-point colours. The present invention may also be implemented in a scanning backlight operated at a display rate.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be constrained as limiting the scope of the claims.

1. Display system comprising:
a display panel for displaying video signals from a video source;
a backlighting unit for backlighting the display panel;
a luminance analyzing unit for analyzing the luminance of at least parts of the video signals from the video source to obtain an analyzing result; and
a backlighting control unit for controlling the-operation of the backlighting unit based on at least one of a first and a second colour temperature of a white-point setting according to the analyzing result of the luminance analyzing unit

2. System according to claim 1, wherein the backlighting control unit is adapted to control operation of the backlighting unit by changing the colour temperature of the white-point setting to the first colour temperature for those parts of the video signal which are unsaturated and bright, wherein the first colour temperature corresponds to about 9300K.

3. System according to claim 1, wherein the backlighting control unit is adapted to control the operation of the backlighting unit by changing the colour temperature of the white-point setting to the second colour temperature for those parts of the video signal which are darker, wherein the second colour temperature corresponds to about 6500K.

4. System according to claim 1, wherein the backlighting control unit is adapted to control the operation of the backlighting unit by changing the colour temperature of the white-point setting to an intermediate value between the first and second colour temperature.

5. System according to claim 1, wherein the backlighting control unit is adapted to control the operation of the backlighting unit by changing the colour temperature of the white-point setting per segment between the first and second colour temperature, wherein a number of the segments corresponds to a total number of individual controllable light sources of the display system.

6. Method for controlling a display system, comprising the steps of:
displaying video signals from a video source on display panel;
backlighting the display panel by a backlighting unit;
analyzing the luminance of at least parts of the video signals from the video source by a luminance analyzing unit to obtain an analyzing result; and
controlling operation of the backlighting unit by a backlighting control unit based on at least one of a first and a second colour temperature of a white-point setting according to the analyzing results of the luminance analyzing unit.
